(19) United States
(12) Patent Application Publication
(10) Pub. No.: US 2015/0097012 A1
(43) Pub. Date: Apr. 9, 2015

(54) Table Tire

(71) Applicant: Ward Haskell Graham, Carson City, NV (US)

(72) Inventor: Ward Haskell Graham, Carson City, NV (US)

(21) Appl. No.: 14/506,649

(22) Filed: Oct. 4, 2014

Related U.S. Application Data
(60) Provisional application No. 61/886,852, filed on Oct. 4, 2013.

(51) Int. Cl. B60R 9/02

(52) U.S. Cl. CPC B60R 9/02
USPC 224/539

(57) ABSTRACT

The “Tire Table” is a foldable, durable and compactable table with a foldable swing arm that attaches to a vehicle tire for it's main support. This foldable swing arm allows the table to be cantilevered, needing no legs, tools or special attachments for installation and use. It is one piece and can be easily removed, folded and stored.

### CROSS-REFERENCE TO RELATED APPLICATIONS

Not applicable

### STATEMENT REGARDING FEDERALLY SPONSORED RESEARCH Not applicable

### BACKGROUND OF THE INVENTION

1. Field of the Invention

This invention relates to a portable, compact table, particularly a table with a single, foldable swing arm support that is cantilevered off a vehicle tire and easily adjusted for different tire widths and does not need table legs for support. Can be installed without tools or specials attachments. It is self-supporting from a vehicle tire and will be stable regardless of the ground conditions.

2. General Background of Invention

The outdoor enthusiast (skier, hiker, biker, snowmobiler, camper, beach goer and the like) or highway road traveler enjoys packing food and eating homemade meals while on the road or while attending “tailgate” parties for football, baseball, fireworks, picnics or other outdoor gatherings.

The “Tire Table” solves the problem of getting your belongings in and out of the back of your vehicle since it is located on the side. Whenever you travel with your vehicle (car, truck, van, SUV, ATV), the “Tire Table” can be easily installed on the vehicle tire, regardless of the ground condition, and will accommodate a portable stove, utensils, food, drinks, lights, tools or any other items you wish to place on it. Folding chairs can also be easily stationed around or near the “Tire Table” for convenience.

### BRIEF SUMMARY OF THE INVENTION

The “Tire Table” solves the problem in a simple and straightforward manner. What is provided is a single piece, compact, foldable table without any additional attachments, quick step up and breakdown, no necessary tools for installation, stable regardless of the ground condition and is compactable to fit in most vehicles, homes, garages, sheds, and the like.

Previously, there have been a variety of folding tables attachable to or extendable from a separate structure. None, however are known to be self-supporting in a manner taught by this invention where no other attachments are necessary to keep the apparatus' in place other than the use of the tire. Examples of different but related foldable and vehicle-attachable tables include a vehicle table described in U.S. Pat. No. 6,467,417 by Guyot; Ehrhardt; Darnell, Froom; Gustaysen & Bohman, issued in Oct. 22, 2002. The Guyot device is a foldable worktable for a work vehicle and implemented as a permanent structure on the vehicle and requires a mounting structure, brackets and support member which many people may not want as a permanent structure on their vehicle. U.S. Pat. No 8,616,630, by Midkiff &Tolbert, issued Dec. 31, 2013. The Midkiff device is a tailgating bench and table combination having a bench frame supporting a bench cushion, and comprising a member insertable into the trailer hitch of a vehicle. Not all vehicles have a trailer hitch or the space in their vehicle for this device since it takes up a lot of space.

### BRIEF DESCRIPTION OF SEVERAL VIEWS OF THE DRAWINGS

FIG. 1—Perspective view of front of table

FIG. 2—Perspective view of rear of table

FIG. 3—Perspective view of right side of table & is the mirror image for left side

FIG. 4—Perspective view of the top of table

FIG. 5—Perspective view of the bottom of table

FIG. 6—Perspective view of the table folded

FIG. 7—Perspective view of front side of table installed on a vehicle tire

FIG. 8—Perspective view of the rear side of table installed on a vehicle tire

FIG. 9—Perspective view of the right side of table installed on a vehicle tire

FIG. 10—Perspective view of the top of table installed on a vehicle tire

FIG. 11—Perspective view of the table with swing arm & table top in open position & ready to install on a vehicle tire

FIG. 12 —Drawing of table's rear support arm that goes around the back of the tire. Shows bend radius, tubing thickness & the steel bar support which is needed to support rear of work surface.

FIG. 13—Drawing of E2 swing arm support with proper measurements, wall thickness, bend radius & hole locations.

FIG. 14—Drawing of table frame measurements, bend radius, length, width & wall thickness.

FIG. 15—Drawing of steel plate with cut radius, thickness, length & width.

FIG. 16—Drawing of length, width & thickness of the rear section of table top surface.

FIG. 17—Drawing of swing arm sleeve. Shows lengths, widths, wall thickness & location of nuts & threaded rod to be welded to swing arm.

FIG. 18.—Drawing of swing arm attachment sleeve with all lengths, widths, wall thicknesses & hole locations.

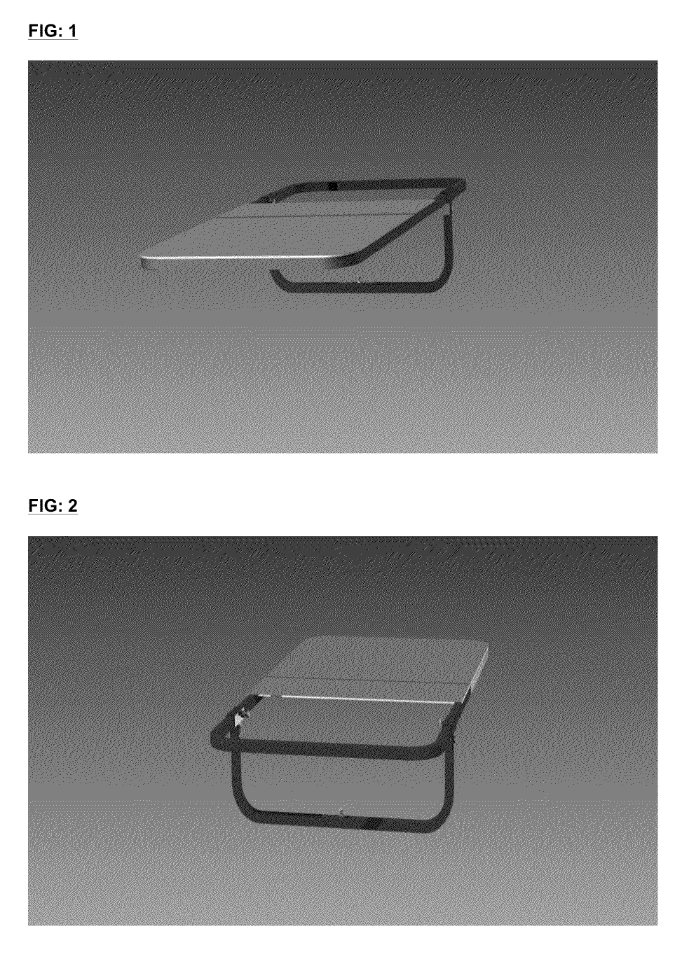

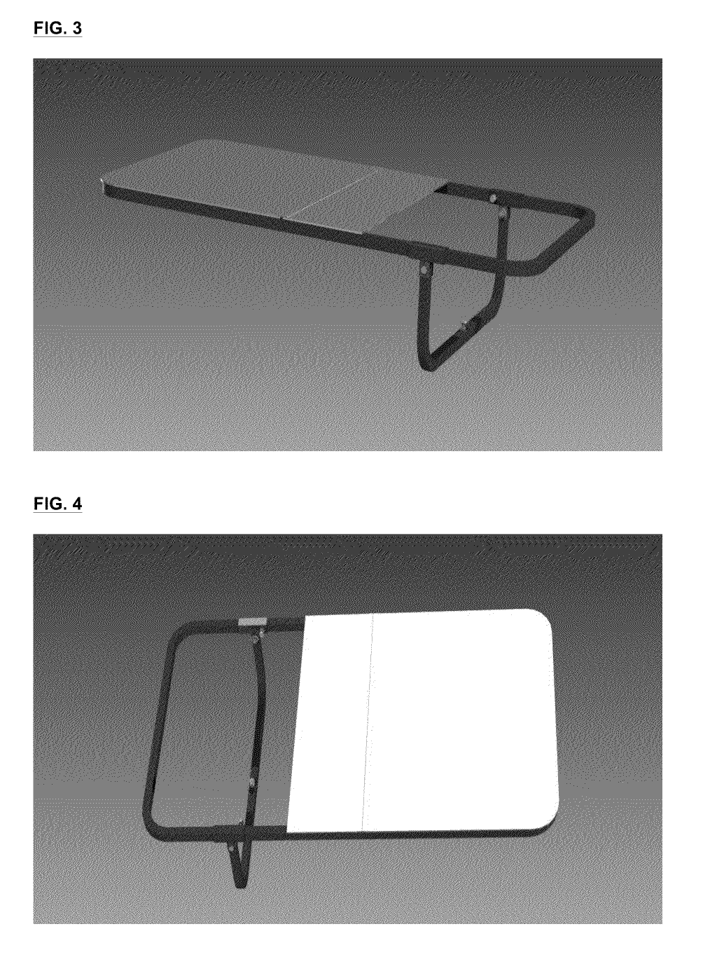

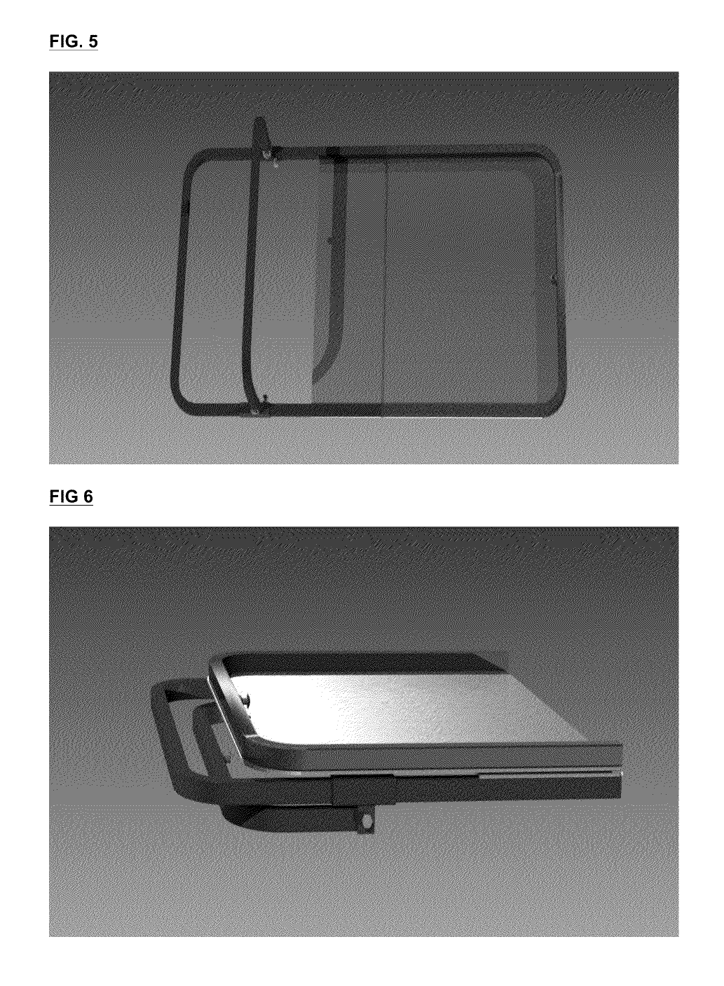

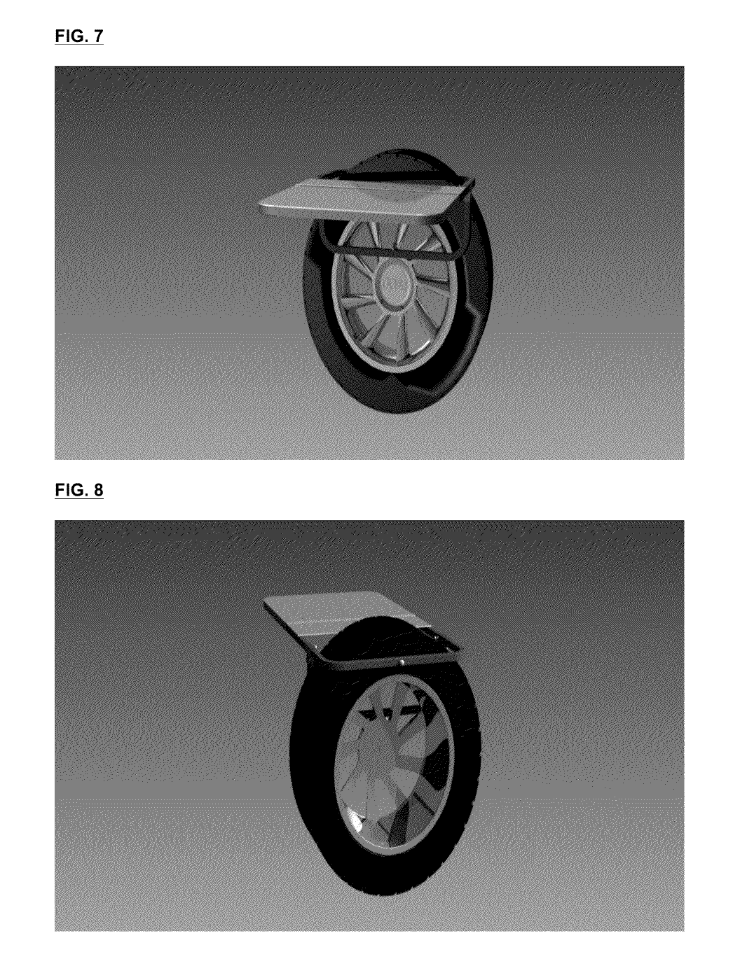

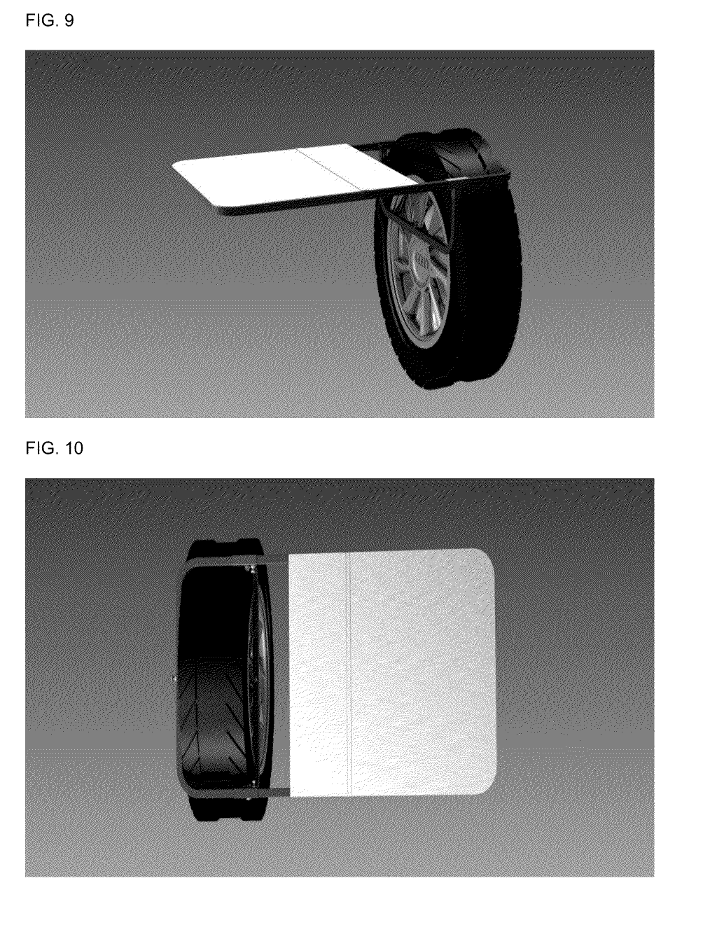

### DETAILED DESCRIPTION OF THE INVENTION

FIG. 19—Table 10. Unfold 11 (table top) which is attached to 12 (table frame) then unfold 13 (swing arm), adjust height of 14 (swing arm adjustment sleeve), install 15 (main frame) onto 16 (the vehicle tire).

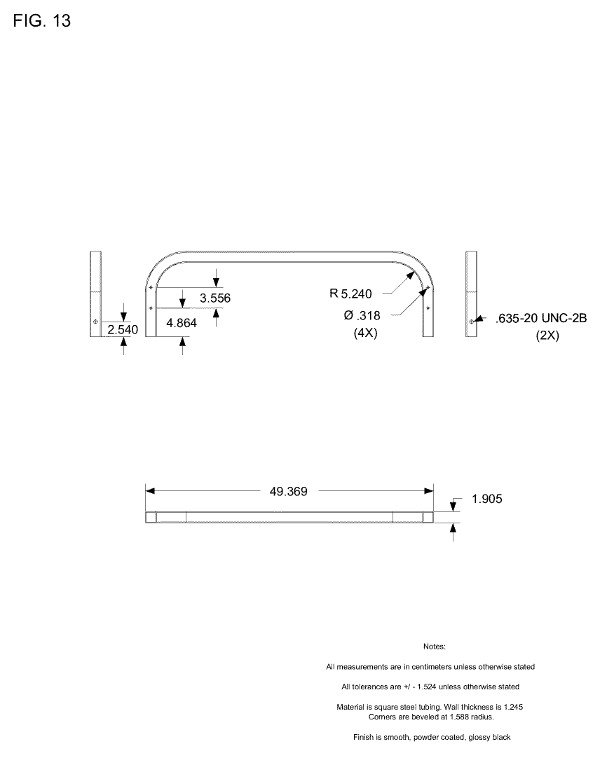

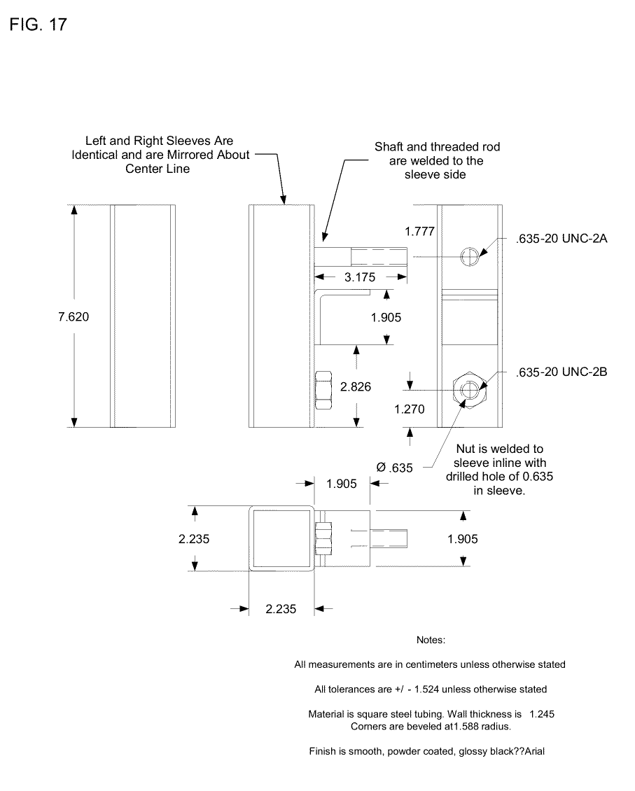

FIG. 17 (Swing arm adjustment sleeves) will have a threaded rod welded to side to act as a pivot for FIG. 13 (the swing arm). It will also have a piece of angle welded to it to act as a stop for FIG. 13 (the swing arm). Last, it will have a nut welded to it. This nut will have a bolt installed which when tightened will act as a stop when you have reached the desired setting. There are two of these FIG. 17 (swing arm adjustments sleeves) needed.

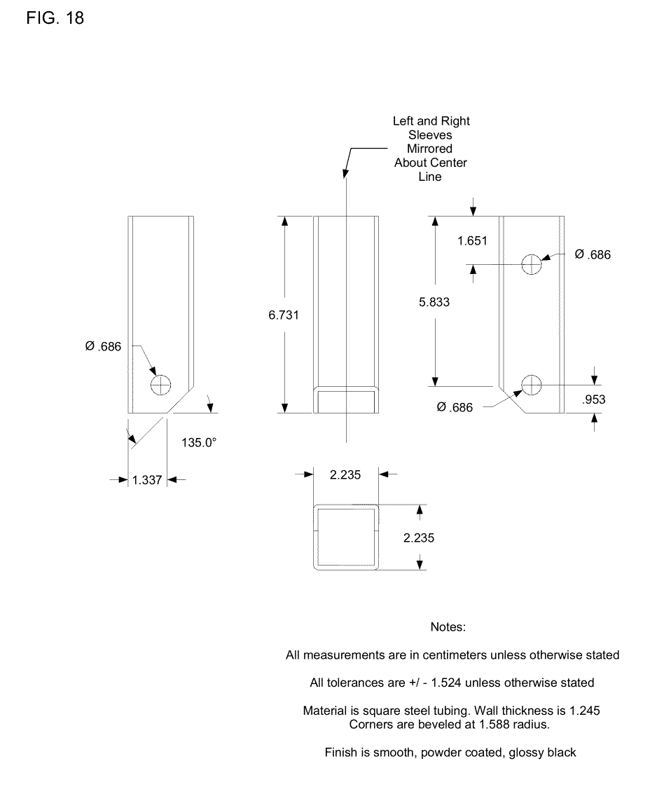

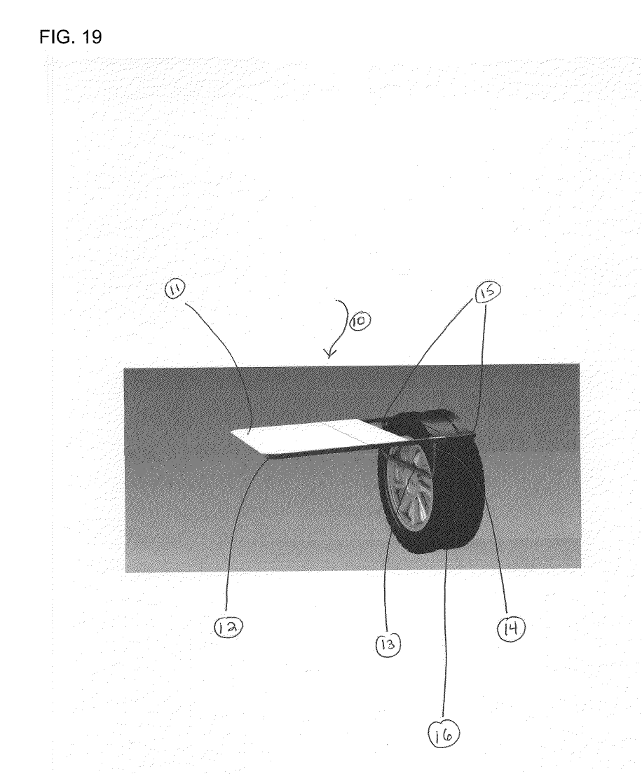

FIG. 18 (swing arm attachment sleeve) will be attached to FIG. 17 (swing arm adjustment sleeve) and installed onto threaded rods with chamfer facing the angle welded to FIG. 17 (swing arm adjustment sleeve).

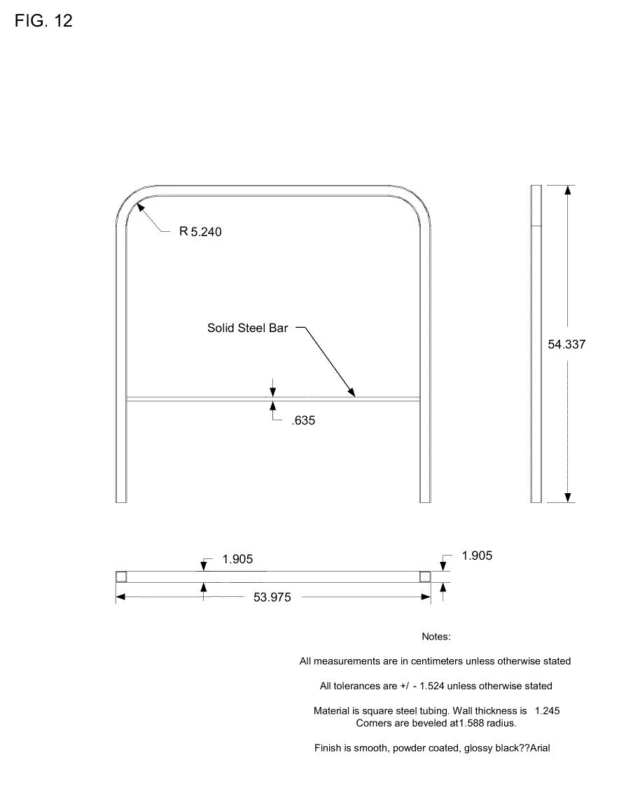

FIG. 13 (Swing arm) will be installed on the two FIG. 18 (swing arm attachment sleeves) and secured with a nut and bolt to the two FIG. 18 (attachment sleeves). Install the FIG. 13 (swing arm assembly) onto the two tubes of the FIG. 12 (main frame) beyond where the steel bar is to be welded. After installed the sleek bar can be welded in place.

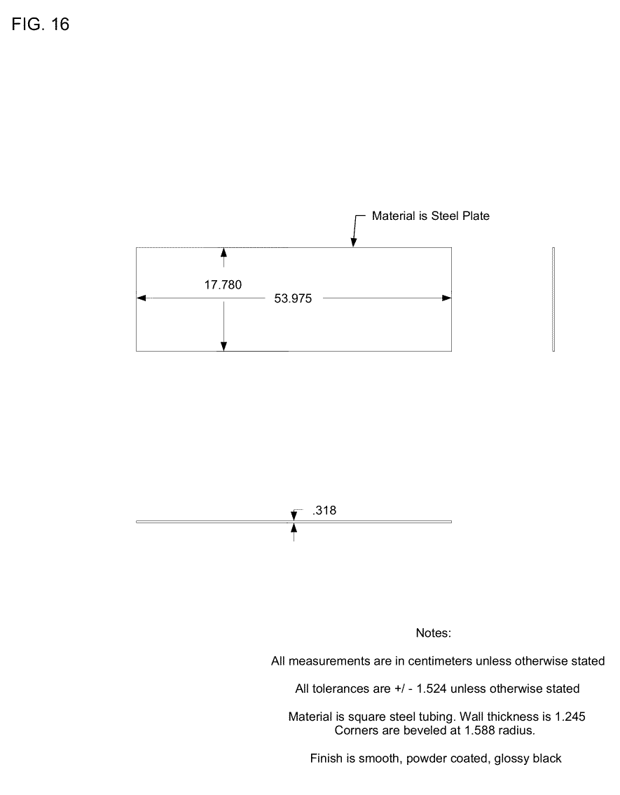

Weld FIG. 16 (steel plate) to FIG. 12 (main frame) and stitch weld in place from steel bar towards open end of FIG. 12 (main frame).

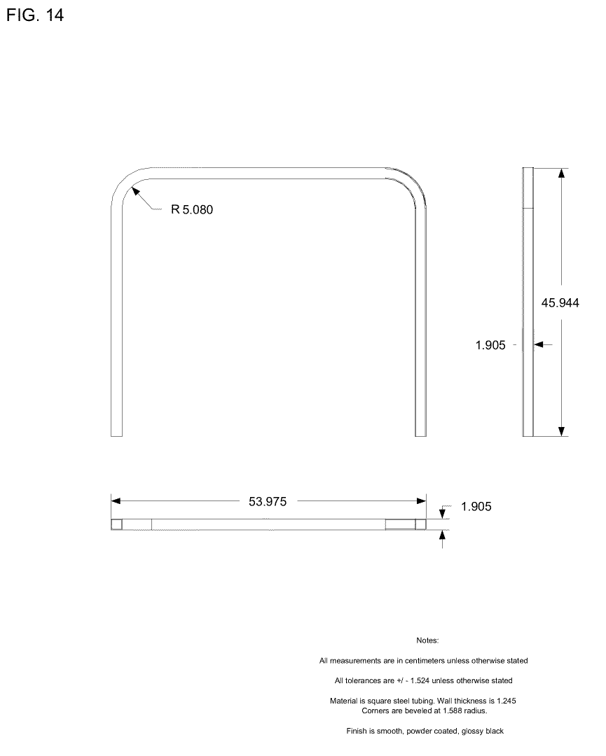

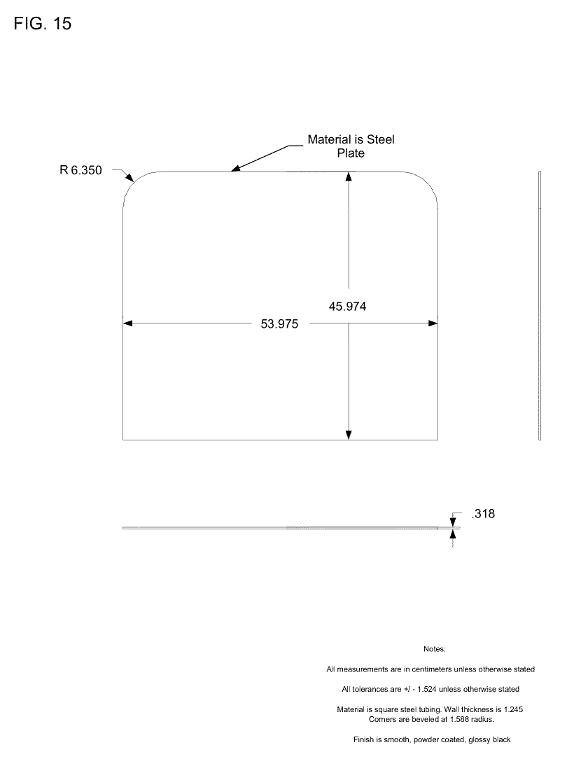

Weld FIG. 15 (table top) to FIG. 14 (table frame) using stitch weld.

Now connect FIG. 14 (table frame) to FIG. 12 (main frame) using a piano hinge. Hinge will be stitch welded to each tables FIG. 15 (steel plate).

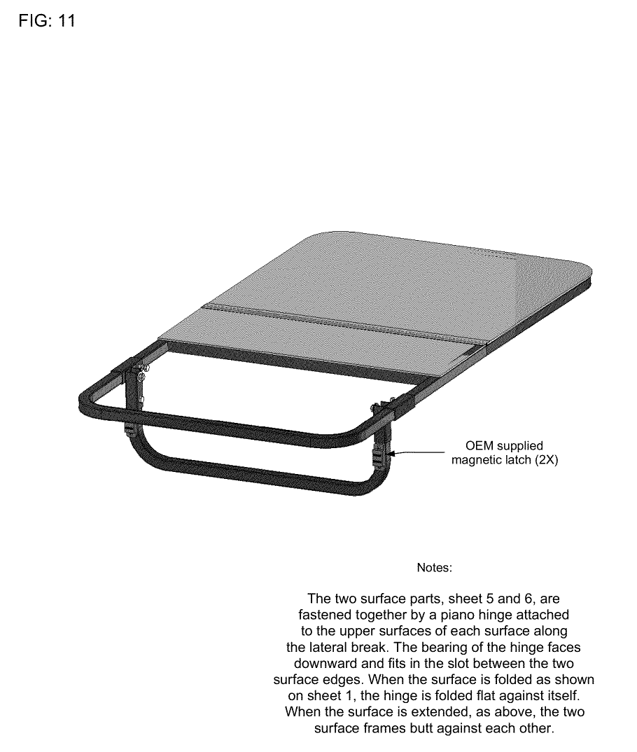

FIG. 11 (table extended) is in open position and ready for use.

What I claim as my invention is:

1. A foldable, durable, compactable, steel square tubular framed table that is supported by a vehicle tire.

2. A foldable vehicle table (claim 1) with an adjustable steel tubular swing arm allowing the table to cantilevered from the vehicle tire.

3. The table (claim 1) is unfolded, the swing arm (claim 2) is unfolded and placed behind the vehicle tire allowing it to be cantilevered without any other objects except the use of the vehicle tire

4. (claims 1 & 2) can be made of aluminum

5. (claims 1 & 2) can be made of titanium

6. (claims 1 & 2) can be made of plastic

7. (claims 1 & 2) can be made of wood

8. (claims 1 & 2) can be made of fiberglass

9. (claim 1) can have an aluminum surface

10. (claim 1) can have a wood surface

11. (claim 1) can have a plastic surface

12. (claim 1) can have a fiberglass surface

13. (claims 1 & 2) can be made with round tubing

14. (claim 1) can be made to have removal leafs

15. (claim 1) can have a permanent leg attachment for holding heavier weight that can be snapped in place under the surface of the table

16. (claim 1) can have a draw to store goods

17. (claim 1) can have attachments for the sides to hold items (drink, phone, tools and the like)

18. (claim 1) the rear part of table has a small table top surface with enough open space for the tubular frame to fit over and behind the tire

19. (claims 1 & 2) the table is supported without legs on the ground making it stable on any ground surface

20. (claim 1) the table can be made to adjust in height

21. (claim 1) the table can be made in different sizes
